(19) United States
(12) Patent Application Publication
(10) Pub. No.: US 2021/0172824 A1
(43) Pub. Date: Jun. 10, 2021

(54) SENSING FLUID FLOW

(71) Applicant: Centrica PLC, Windsor, Berkshire (GB)

(72) Inventors: Oliver PARSON, Windsor, Berkshire (GB); Ryszard MACIOL, Windsor, Berkshire (GB); Spiros MOURATIS, Windsor, Berkshire (GB); Mario BONAMIGO, Windsor, Berkshire (GB)

(73) Assignee: Centrica PLC, Windsor, Berkshire (GB)

(21) Appl. No.: 17/268,651

(22) PCT Filed: Aug. 15, 2019
(86) PCT No.: PCT/GB2019/052298

§ 371 Date: Feb. 16, 2021

(30) Foreign Application Priority Data
Aug. 16, 2018 (GB) 1813396.7

(51) Int. Cl. G01M 3/28; F17D 5/02; G01F 1/704

(52) U.S. Cl. CPC G01M 3/2807; G01F 1/704; F17D 5/02

(57) ABSTRACT

In one example, there is provided a computer-implemented method for estimating, at a given time, a fluid flow state in a conduit of a property, comprising: obtaining historical data associated with at least one fluid flow state in the conduit, wherein the historical data comprises a history of the probability of the at least one fluid flow state in the conduit; obtaining a probability model for the at least one fluid flow state, wherein a probability for the at least one fluid flow state is a function of the historical data associated with the at least one fluid flow state; obtaining observed data associated with the property, the observed data including a measure representative of fluid flow in the conduit; and estimating a fluid flow state in the conduit of the property at the given time, based on the historical data associated with the at least one fluid flow state, the probability model and the observed data.

### CROSS-REFERENCE TO RELATED APPLICATIONS

This application is a national phase application of International Application No PCT/GB2019/052298, filed Aug. 15, 2019, which claims priority to Great Britain Patent Application Serial No. 1813396.7, filed Aug. 16, 2018, all of which are incorporated herein by reference.

### BACKGROUND

Leaks in a property can cause significant damage and may be difficult to detect until serious damage has occurred. A technical solution which provides early warning of potential leaks would therefore be advantageous but despite the long-standing problem, no simple and effective solution has been proposed. Placing a network of fluid detectors adjacent pipes, pressure and/or flow sensors on pipes and fluid consumers and throughout a property's pipe network can give some warning but is expensive and technically difficult to install and configure as pipes may be inaccessible and in any event such a solution still does not reliably detect leaks. It is difficult to detect a leak in a conduit of a property based simply on fluid flow, because it is difficult to distinguish between an intended use of the fluid (such as a flush and/or a shower in a case where the fluid is water) and a problematic leak where the fluid is simply wasted.

### SUMMARY

The invention relates but is not limited to sensing fluid flow or detecting leaks or a method for estimating, at a given time, a fluid flow state in a conduit of a property. In examples of the disclosure, the fluid flow state may be estimated as a leak state or a non-leak state.

Aspects and embodiments of the invention are set out in the appended claims. These and other aspects and embodiments of the invention are also described herein.

In one aspect, the disclosure provides a leak detection method for detecting a leak in a conduit of a property. The method comprises obtaining a probability model depending on historical data comprising at least one probability of a leak state in the past, and observed data associated with the property at present (the observed data including e.g. a measure representative of fluid flow in the conduit). The method comprises determining a likelihood of a leak in the conduit at a present time by assigning a probability of a fluid flow state in the conduit of the property being a leak state, using the probability model.

Surprisingly it has been found that by using a probability model using historical data including a probability of a leak state in the past, a more useful determination of a leak state can be determined.

An alert may be output in response to determination of a likely leak in the conduit.

Although primarily the method is useful for detecting leaks, the techniques can be used more broadly for estimating the state of fluid flow and in another aspect the disclosure provides a method for categorising a fluid flow state in the conduit, the fluid flow state including a leak state or a non-leak state. The method comprises obtaining historical data associated with the fluid flow state in the conduit, a probability model for the fluid flow state (where a probability of a given fluid flow state is a function of the historical data), observed data associated with the property (the observed data including e.g. a measure representative of fluid flow in the conduit), and estimating a fluid flow state in the conduit of the property, based on the historical data, the probability model and the observed data.

In some examples the fluid flow state may be one of a predetermined set of discrete states including a leak state and a non-leak state. Estimating the fluid flow state may comprise assigning a probability of a flow state at the present time.

Embodiments of the disclosure may enable or may facilitate detection of a leak in the conduit of the property. Alternatively or additionally, embodiments of the disclosure may enable or may facilitate distinguishing between an intended use of the fluid (such as a flush and/or a shower in a case where the fluid is water) and a leak where the fluid is simply wasted. Alternatively or additionally, embodiments of the disclosure may enable or may facilitate categorising the fluid flow state in the conduit, the fluid flow state including, but not being limited to, a leak state or a non-leak state.

It should be noted that there have been a number of proposals to determine a leak state based on available data such as temperature of fluid flow and improvements have been proposed to increase the quality or precision of the data or improve its processing or to correlate it with other data. Such techniques and future improvements in refining the data or using more data may be used in conjunction with embodiments. However, pursuant to the disclosure, it has been appreciated that using the historical determination of a given flow state, as an input to the determination of a current flow state may give an advantage over simply improving the current data or its processing. This may be seen as slightly surprising as a previous determination may have been wrong and circumstances may have changed (a determination that there was not a leak previously but a slow usage of water may have been wrong and even if correct the state will invariably have changed if a leak occurs).

Moreover, it has been found pursuant to the disclosure that keeping as historical data not simply a historical estimate of the flow state but the historical probability determined of that flow state may give greatly improved current estimates. The latter may be more surprising as the previous probability determined does not itself have an external consequence (the state was as a matter of fact a leak or not). A number of known mathematical techniques or machine learning techniques may be applied to the data.

### BRIEF DESCRIPTION OF THE DRAWINGS

Embodiments of the present invention will now be described, by way of example, with reference to the accompanying drawings, in which:

FIG. 1 shows a flow chart illustrating an example method according to the disclosure;

FIG. 2 schematically illustrates an example system and an example device configured to implement the example method of FIG. 1;

FIG. 3 shows a flow chart illustrating another example method according to the disclosure;

FIG. 4 schematically illustrates an example probability model PM, example historical data HD and example observed data OD;

FIG. 5 schematically illustrates example data from a property over a three month period; and

FIG. 6 schematically illustrates the ambient and conduit temperatures as measured by a device, and a water temperature as estimated by a water supply estimation.

In the figures, similar elements bear identical numerical references.

### DETAILED DESCRIPTION

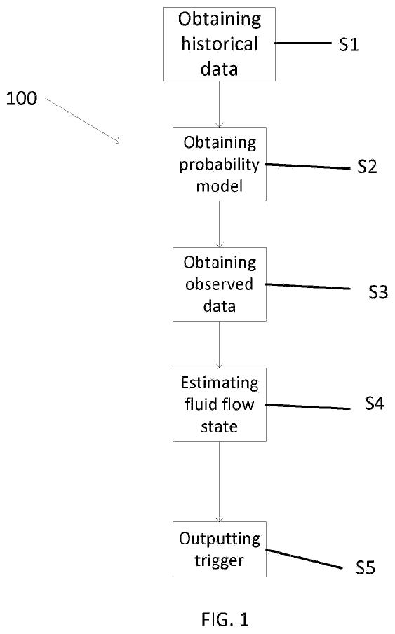

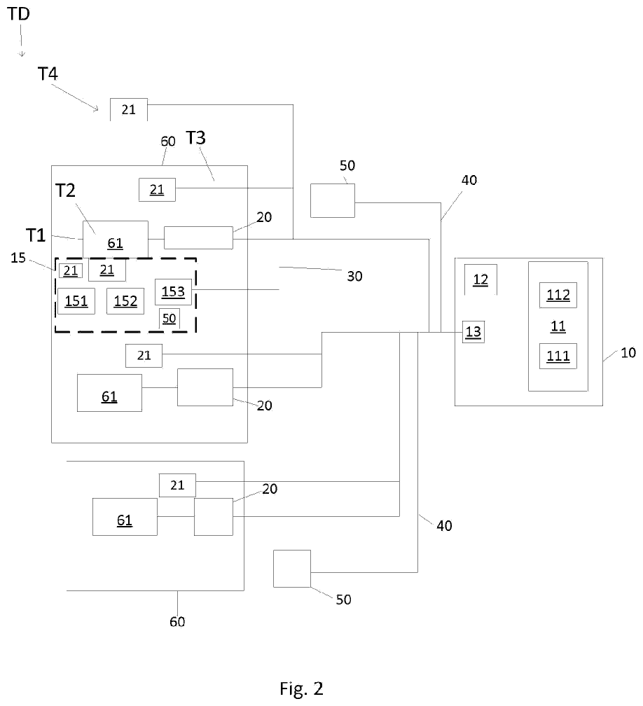

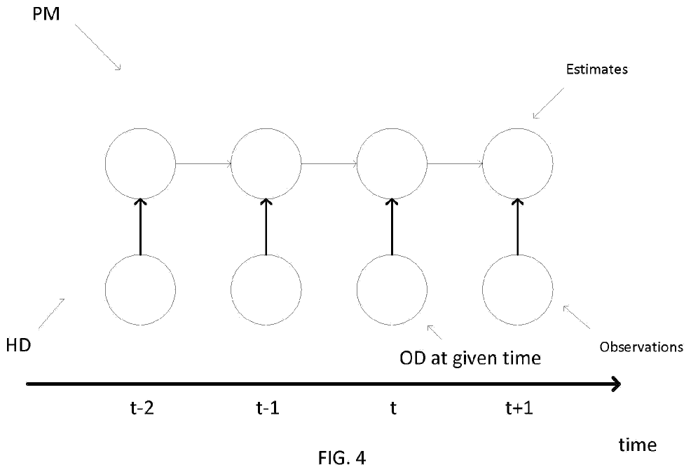

FIG. 1 shows a flow chart illustrating an example method 100 according to the disclosure. The method 100 is illustrated in FIG. 1, in connection with FIGS. 2 and 4. FIG. 2 schematically illustrates an example system 10 and device 15 configured to implement, at least partly, the example method 100 of FIG. 1. FIG. 4 schematically illustrates an example probability model PM, example historical data HD and example observed data OD used to implement, at least partly, the example method 100 of FIG. 1. The method 100 may be for estimating, at a given time t, a fluid flow state in a conduit 61 of a property 60.

The method 100 of FIG. 1 comprises: obtaining, at S1, historical data HD associated with at least one fluid flow state in the conduit 61, and obtaining, at S2, a probability model PM for the at least one fluid flow state.

In the PM, a probability for the at least one fluid flow state may be a function of the historical data HD associated with the at least one fluid flow state. Alternatively or additionally, in the PM, a probability for the at least one fluid flow state may be a function of observed data OD. In some examples the observed data OD may be associated with the property, the observed data including e.g. at least one measure representative of fluid flow in the conduit.

In some examples, the historical data HD may comprise a history of the probability of the at least one fluid flow state in the conduit, e.g. at one or more previous times (such as t-2 or t-1) prior to the given time t, as illustrated in the example timeline of FIG. 4. Alternatively or additionally, the historical data HD may comprise the history of the fluid flow state, such as a leak state and/or a non-leak state as non-limiting examples.

The method 100 of FIG. 1 further comprises obtaining, at S3, the observed data OD associated with the property 60.

In some examples, the observed data OD may include a measure representative of a fluid flow in the conduit 61.

In some examples, the observed data OD may comprise a history of the measures representative of the fluid flow in the conduit 61, e.g. at one or more previous times (such as t-2 or t-1) prior to the given time t.

The historical data HD and/or the observed data OD preferably comprise data recorded at intervals of less than 24 hours or at least once per day. Most preferably the historical data HD and/or the observed data OD include both historical measures associated with the property and/or the flow itself (such as a history of the observed data) and a record of e.g. a history of the determined probability of the flow state being a particular flow state.

More preferably the historical data HD and/or the observed data OD includes several readings per day, typically at least morning, day, evening and night or at least about four readings per day. In some examples the historical data and/or the observed data may comprise readings separated by a much lower interval, such as a second, five seconds or ten seconds as non-limiting examples.

The sampling intervals need not be equal and in some embodiments sampling times may be adjusted based on observed usage, for example so that usage at morning, evening, night etc., corresponds to times of typical usage.

Although the flow data and probability data will typically be determined and stored at similar intervals, this is not essential and for example the flow rate may be stored at a particular frequency, for example hourly or at 15 minute intervals, but the probability of a particular flow state may be recorded at less frequent intervals, for example every 2 hours or every 4 hours.

In some cases the data may be sampled and recorded more frequently initially than it is stored for long term use. For example samples of flow rate or temperatures, may be taken every 15 minutes or more frequently (such as every second or every 10 seconds as non-limiting example) and may be stored short term at the sampling frequency but the data may be stored as consolidated historical data and/or observed data only at longer intervals for example hourly after an initial period, such as 24 hours or 7 days, to reduce the volume of historical data and/or observed data to be stored and processed.

It will be appreciated that in general it may be helpful to record whatever data is readily available without requiring dedicated sensors even if dedicated sensors are available. Moreover the data recorded and used may be varied from installation to installation depending on circumstances and data availability. Methods for determining a measure of fluid flow based on temperature differences in a conduit are disclosed, for example, in UK patent application numbers GB 1604170.9 (published as GB 2536364), GB 1717195.0, GB 1718195.9 and PCT application number PCT/GB2017/051970 (published as WO2018/007802), the disclosures of which are herein incorporated by reference and may be used or modified as desired or coupled with data from dedicated flow sensors.

Alternatively or additionally, the observed data may comprise additional data, for example from a security system or lighting controller or proximity sensing, for example based on mobile device location of occupants or expected occupants, data traffic, utility demand such as electricity consumption or heating demand may also be used as inputs to determination of a likely fluid flow state. The important point about embodiments is that while they may take advantage of numerous techniques and future improvements in processing that data to determine a likely fluid flow state in a property based on available data, the embodiments take into account historical data giving a historical measure of probability of a given fluid flow state and/or into account the observed data. Thus, whatever live observed data is used, for a given fixed set of inputs of currently observed data the output determination of fluid flow state for embodiments may be different dependent on the history of the observed data.

In some examples, and as illustrated in FIG. 2, the measure representative of the fluid flow may comprise temperature data TD based on a temperature T1 of the conduit 61. Alternatively or additionally the temperature data TD may comprise a temperature T2 of a fluid located in the conduit 61.

In some examples, the measure representative of the fluid flow further comprises a determined gradient of the temperature T1 of the conduit and/or of the temperature T2 of the fluid in the conduit.

Alternatively or additionally, in some examples, the observed data OD may comprise temperature data TD based on a temperature T3 of the property 60, such as a temperature in a room of the property. The temperature in the room of the property 60 may comprise the ambient temperature of the air surrounding the conduit 61. Alternatively or additionally the observed data OD may comprise temperature data TD based on a temperature T4 external to the property 64, such as a meteorological temperature.

In some examples, the observed data OD may further comprise data representative of a difference between:

on the one hand, the temperature T3 of the property and/or the temperature T4 external to the property, and

on the other hand, the temperature T1 of the conduit and/or the temperature T2 of the fluid in the conduit.

The observed data OD may thus comprise data representative of (T3-T1) as a non-limiting example. In some examples the temperature T1 of the conduit and/or the temperature T3 of the air surrounding the conduit are measured, e.g. by temperature sensors 21 (e.g. thermistors) and/or a device 15 described in more detail below, e.g. every 10 seconds.

Alternatively or additionally, in some examples, the observed data OD may comprise a number of features which are calculated from a window of temperature data (e.g. the past 100 temperature readings ˜e.g. 15 mins of data, as a non-limiting example).

In some examples the calculated features may be used as an input in the PM described in more detail below.

Examples of such calculated features include the gradient of the conduit temperature T1, a measure of the linearity of the gradient of the conduit temperature T1 (e.g. how straight a representation of the gradient is), the fluid temperature T2 and/or a flow ratio.

In some examples, the fluid temperature T2 may be determined from multiple days of temperature data in relation to the temperature T1 of the conduit 61 and/or the temperature T3 of the air surrounding the conduit 61.

In some examples, the flow ratio, which may be another calculated feature used as an input into the probability model, may be calculated as described in more detail below.

In some examples, the sampling frequency of the raw temperature data (such as the measurements of the temperatures T1 and T3) and/or of the calculated features (e.g. used as input into the probability model) may be e.g. between 1 second and 15 minutes, e.g. every 10 seconds as non-limiting examples.

In some examples, the measure representative of the fluid flow may further comprise data associated with a fluid meter 20.

The method 100 of FIG. 1 further comprises estimating, at S4, a fluid flow state in the conduit 61 of the property 60 at the given time t, based on the historical data HD associated with the at least one fluid flow state, the probability model PM and the observed data OD.

The system 10 of FIG. 2 comprises at least a memory 11, a processor 12 and a communications interface 13.

In FIG. 2, the system 10 may be configured to communicate with one or more fluid meters 20 and/or one or more temperature sensors 21 and/or one or more devices 15, via the interface 13 and a first link 30 (e.g. Wi-Fi connectivity).

The system 10 of FIG. 2 is also configured to be connected to one or more user interfaces 50, via the interface 13 and a second link 40 (e.g. Wi-Fi connectivity) between the interface 13 and the user interfaces 50.

The memory 11 is configured to store data, for example for use by the processor 12. The memory 11 may also comprise a first database server 111 configured to store data. The data may comprise at least one of the historical data HD, the probability model PM and/or the observed data OD.

The memory 11 may also comprise a second database server 112 configured to store data received from the user interfaces 50 over the link 40.

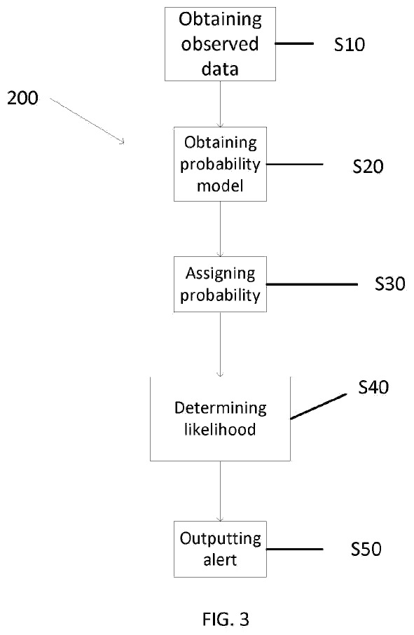

In some examples, the processor 12 of the system 10 may be configured to perform, at least partly, at least some of the steps of the method 100 and/or a method 200 of FIG. 3. Alternatively or additionally, some of the steps of the above methods may be performed, at least partly, by another entity in the system 10, such as the server 111 or 112 as non-limiting examples.

Alternatively or additionally, the device 15 of FIG. 2 comprises at least a memory 151, a processor 152 and a communications interface 153 (e.g. Wi-Fi connectivity) to the interface 13. The device may also comprise one or more temperature sensors 21 and/or one or more user interfaces 50. In some examples, the processor 152 of the device 15 may be configured to perform, at least partly, at least some of the steps of the method 100 and/or the method 200.

In some examples, the device 15 may be battery-powered device with the interface 153 having Wi-Fi connectivity. In some examples, the device 15 may only connect to the system 10, e.g. every 6 hours (e.g. to save battery life), unless a leak has started or ended, in which case the device 15 may connect to the system 10 e.g. immediately. In some examples, the device 15 may perform some of the steps of the method 100 and/or 200, e.g. in order to determine whether a leak has recently started or ended.

Alternatively or additionally, in some examples, the device 15 may send all new temperature data (e.g. sampled at ten second intervals) to the system 10, each time the device 15 may connect to the system 10. In some examples, the system 10 may perform some of the steps of the method 100 and/or 200 to confirm the fluid state.

In some examples the system 10 may output the trigger data (e.g. the system 10 may send a notification to the person living in the property) if a new leak has started.

Additionally or alternatively, the system 10 may classify each leak as either a large or small water flow as described in more detail below.

In some examples, at least one meter 20 may comprise at least one of a fluid meter of the property, such as a smart meter e.g. for a liquid (such as water). In some examples the fluid may be a gas instead of a liquid, such as natural gas.

At least some of the meters 20 may be configured to generate one or more readings comprising fluid consumption data. Alternatively or additionally, at least some of the temperature sensors 21 may be configured to generate one or more readings, such as T1, T2, T3 and/or T4 as described above.

In some examples, at least some of the meters 20 and/or temperature sensors 21 may be classical meters. In that example, the readings are displayed on a user interface of the meter/sensing device, and need to be transmitted to the system 10 and/or the device 15 by a person associated with the property or by an operator of the utility provider (water and/or natural gas) as non-limiting examples. The readings can be transmitted to the system 10 and/or the device 15 using the user interfaces 50. In some examples, at least some of the meters 20 and/or temperature sensors 21 may comprise an automatic meter/sensor reading functionality. The automatic meter reading/sensor functionality may be configured to automatically collect the fluid consumption data relating to the meter and/or temperature associated with the temperature sensor 21, and to transfer the data to the system 10 and/or the device 15 over the first link 30. The period between each transfer may correspond, for examples, to a billing period, such as a month, a quarter, or a year as non-limiting examples. In some examples, at least some of the meters 20 and/or temperature sensors 21 may comprise or be in the form of smart meters. The smart meters are meters comprising an automatic meter reading functionality, as well as other functionalities, for example for communication to the system 10 and/or the device 15, such as a short term readings (for example a reading may be generated every half hour or every 10 seconds) and/or real-time or near real-time readings, as non-limiting examples.

In some examples the at least one fluid flow state is one of a predetermined set of discrete states including a leak state and a non-leak state.

Alternatively or additionally, the discrete states may include one or more leak sub-states, such as severity sub-states including

e.g. at least two sub-states, such as one low severity sub-state and one high severity sub-state, or

e.g. at least three sub-states such as one low severity sub-state, one medium severity sub-state and one high severity sub-state.

Alternatively or additionally, the discrete states may include, as non-limiting examples, a device 15 off-pipe state (e.g. representative of a state when the device 15 is not connected to the conduit 61), a device 15 poor connection state (e.g. representative of a state when the device 15 is not properly connected to the conduit 61). Alternatively or additionally, the discrete states may include a filling of header tanks state (e.g. representative of a state involving filling of one or more water tanks in an attic and/or a loft of the property, e.g. to ensure pressure to upstairs taps).

Some examples of the above example discrete states will be described in more detail below.

In some examples the device 15 may be mounted on at least one conduit 61, as illustrated in FIG. 2. In most cases, the installation of the device 15 is straightforward. However, conduits in the properties vary widely from a property to another property. This results in a small fraction (approx. 10-20%) of poorly installed devices 15. A poor mounting of the device 15 on the conduit 61 may create a poor customer experience, due to e.g. missed leaks and false positive alerts.

In some examples, the observed data collected during a mounting phase and/or within an initial period may be used to detect cases of bad installation, potentially enhanced by repeating the collection of the observed data at regular intervals for the whole life of the device 15.

The main reasons for poor installations may comprise at least one of the following (in descending order of frequency): the device 15 not being attached to a conduit (about 50% of the cases), the device 15 being attached to the wrong conduit (i.e., hot water, gas or secondary branch pipe), the device 15 having a poor connection to the conduit (e.g. the device 15 being attached at a joint/bend in the conduit), and the device 15 being attached to a pipe with a warm conduction (e.g. due to proximity with boiler or other hot pipes).

Each of the above mentioned scenarios manifests itself differently in the conduit temperature and in the ambient temperature. Therefore a different detection strategy may be adopted for each of the bad installations mentioned above. Alternatively or additionally, the ability to identify the specific reason for the poor installation may allow notifying the customer and/or the person living in the property with a more tailored suggestion on how to fix the problem. Each type of bad installation is described in more detail in the following.

In cases where the device 15 is not on the conduit, as the device 15 is not in contact with any conduit (e.g. via at least one temperature sensor 21) and is in thermal equilibrium with the surrounding air, the conduit temperature and the ambient temperature fluctuate in a very similar way.

Moreover, no steep change in temperature is observed, which would be normally caused by attaching the device 15 to a conduit and by usage events. Therefore in some examples detection of devices 15 that are not attached to conduits may be performed by simply checking for absence of usage events in a given period of time.

In cases where the device 15 is installed on hot conduits (e.g. conduits that carry hot water), fluid flows are typically rare events so that the conduit is normally cold at the time of installation. As a result, the absence of usage may not be used to detect devices 15 installed on hot conduits. Therefore in some examples detection of devices 15 installed on hot conduits may be performed by using a threshold on the conduit temperature.

In cases where the device 15 is installed on gas pipes (or non-water carrying conduits), the devices 15 are characterised by a drop in temperature when the device 15 is attached to the conduit and by a different response of the conduit temperature to changes in ambient temperature, as the device 15 is in contact with a solid body that has a different thermal capacity than air.

Therefore in some examples detection of devices 15 installed on non-water carrying conduits may be performed by the continued absence of usage after the initial temperature drop, once the device 15 has reached thermal equilibrium with the conduit.

By design the device 15 may only be able to detect leaks that are downstream of its location on the conduit. Therefore the device 15 is usually installed upstream of any branch. It should be noted that cases where the device 15 is installed on a branch pipe might be an intentional installation, as the person living in the property might be interested only on leaks on a specific pipe. However the more common occurrence of this scenario is due to the presence of multiple water conduits at the location where the water enters the property, which causes the customer to mistakenly install the device 15 on a branch conduit. In cases where the device 15 is installed on a branch pipe, detection may be performed by the rare detection of usages, approximately one or two per day, which characterise the flow in secondary branch conduits.

In cases where the device 15 is poorly connected to the conduit, a low difference exists between ambient temperature and conduit temperature when water is flowing. This problem usually causes smoother curves at otherwise sharp points like start and end of flow. Detection may be performed by using a classifier, developed to identify low-difference situations, in order to detect bad installations caused by poor connection.

In cases where the device 15 is connected to a conduit with a warm conduction (e.g. from nearby heat sources, i.e. boilers or hot pipes), during periods where water flow is absent, the conduit temperature may converge to a value higher than the ambient temperature, preventing convergence of temperature from being detected by the device 15 and possibly resulting in false leak alerts. Unlike in all previous cases, in this situation the device 15 can still potentially detect real leaks. The detection may be performed by comparing the sign of the (ambient temperature-conduit temperature) difference, averaged within a long sliding window or during stable periods, and compare the sign with the same value measured during usage events. When the two signs are different then the conduit is classified as being affected by warm conduction.

In some examples, detection of each of the above categories of bad installation is performed as soon as possible. The first opportunity to detect a bad installation is during the mounting, although there is very little data available at this point. Subsequent opportunities exist 24 hours after the mounting process while the person living in the property is still highly engaged, but also this check can be applied at any time during the device's lifetime (e.g. to check the device 15 has not been knocked off the conduit).

In some examples detection may be performed at the mounting of the device 15. It may be possible to detect a usage (e.g. water flowing) if the user follows these steps: attach the device 15 to the conduit, flush the toilet (causing water to flow through the conduit, and therefore changing rapidly the conduit temperature) and causing the device 15 to upload the observed data. A similar drop in conduit temperature may be observed when a device 15 is attached to a conduit, as the stop-tap is typically in a location at a different temperature and the conduit is a very good heat conductor. For these reasons, at the mounting it may be possible to accurately detect the case when a device 15 is not attached to a conduit.

Alternatively or additionally, bad installations may be detected after having waited for a period of time after the installation, so that it is more likely to observe the different signatures of the various bad installation scenarios. In some examples, a 24-hour period may capture most of the bad installations, given that it allows the device 15 to observe a full daily schedule of the person living in the property.

Alternatively or additionally, testing for bad installations may be performed at periodic intervals of time. These may differ for each particular bad-installation type, depending on how easy it is to fix the detected problem. For example, the person living in the property might want to be notified within a day if the device 15 has fallen off the conduit, but might not want to receive notifications every day in the case of warm conduction if the person living in the property cannot fix the problem.

In some examples, estimating at S4 the fluid flow state comprises assigning a probability of a flow state at the given time t and/or at one or more previous times prior to the given time t.

In some examples, the probability at the given time t may be a function of the probability at one or more previous times (such as referred to t-1 and/or t-2 as non-limiting examples) prior to the given time t, and/or of the observed data (such as the temperature T1, T2, T3 and/or T4 as non-limiting examples) at the given time t and/or at one or more previous times. In some examples, the method comprises obtaining the observed data OD associated with the property at the given time t and/or at one or more previous times.

In some examples, estimating at S4 the fluid flow state in the conduit 61 at the given time t may be made in relation to a predetermined probability threshold.

In some examples of a two-discrete-state model (e.g. leak and no-leak), an example predetermined probability threshold may be 0.5, with a sum of the probability of a leak and of the probability of a no-leak being 1.

In some examples the predetermined probability threshold may be at least partly determined based on a user input (e.g. using the interface 50), associated with a sensitivity level chosen by the user. The user may thus choose the sensitivity level for the leak detection.

In some examples, predetermined probability thresholds other than 0.5 described above may be used to adjust the sensitivity level, e.g. leaks might only be detected if the probability of the leak state is greater than 0.75 or greater than 0.25, as non-limiting examples. In models with more than two discrete states, lower probabilities may be used since there are more different possible states.

Optionally the method may further comprise outputting, e.g. at S5, trigger data to trigger an intervention in response to estimating that the flow state at the given time is a leak state. The intervention may include outputting an alarm signal and/or trigger a further estimation of the state (e.g. for verification). In some examples, several types of alarm signals may be considered. The different types of alarm signals may enable taking into account the seriousness of the estimated state. A first type of alarm signal may cause a message being sent to a person living in the property (such as a text message, a phone call, etc.). A second type of alarm signal may cause a visit of a professional maintenance staff (such as a plumber) to the property. Other types of alarm signal are envisaged.

As already explained, in some examples the method 100 illustrated in FIG. 1 may be implemented, at least partly, for detecting a leak, at the given time t, in the conduit 61 of the property 60. In that context, the at least one fluid flow state is a leak state. Alternatively or additionally, a probability of the at least one fluid flow state being a leak state at the given time is a function of the historical data HD comprising a probability of the at least one fluid flow state being a leak state at one or more previous times t-1 and/or t-2 prior to the given time t, and of the observed data OD, e.g. at the given time t and/or at one or more previous times.

Alternatively or additionally, estimating at S4 the fluid flow state may comprise assigning a probability of the at least one fluid flow state being a leak state, e.g. at the given time and/or one or more previous times, using the probability model PM.

The method may further comprise, e.g. at S4, determining a likelihood of a leak in the conduit 61 of the property 60, based on the assigned probability; and outputting an alert, e.g. at S5, in response to determining a likely leak in the conduit 61 of the property 60.

FIG. 3 shows a flow chart illustrating another example method 200 according to the disclosure. The method 200 is illustrated in FIG. 3, in connection with FIGS. 2 and 4. FIG. 2 schematically illustrates the example system 10 and device 15 configured to implement, at least partly, the example method 200 of FIG. 3. The method 200 may be for detecting a leak, at a given time t, in the conduit 61 of the property 60.

The method 200 of FIG. 3 comprises:

obtaining, at S10, observed data including a measure representative of a fluid flow in the conduit 61; and

obtaining, at S20, a probability model PM for at least one fluid flow state being a leak state.

In some examples, a probability of the at least one fluid flow state being a leak state at the given time may be a function of historical data HD comprising at least one probability of the at least one fluid flow state being a leak state at at least one previous time (such as t-1 and/or t-2) prior to the given time t, and/or of the observed data OD at the given time t and/or at one or more previous times as illustrated in FIG. 4.

The method 200 of FIG. 3 further comprises:

assigning, at S30, a probability of the at least one fluid flow state being a leak state, e.g. at the given time t and/or at one or more previous times, using the probability model PM;

determining, at S40, a likelihood of a leak in the conduit of the property, based on the assigned probability; and

outputting, at S50, an alert in response to determining a likely leak in the conduit of the property.

In both methods 100 and 200, the probability may be a continuous variable comprised between 0 and 1 (such as a real number). In some examples the probability may be a non-integer value. In some examples the probability may have at least 16 bits of precision.

In some examples, at S40 determining the likelihood of the leak in the conduit of the property may be made in relation to a predetermined probability threshold. The predetermined threshold may be predetermined as already described in the present disclosure.

In some examples, the probability model PM comprises a Bayesian network. In some examples the PM may take into account the historical data associated with at least one fluid flow state, e.g. assigned based on empirical data.

In some examples, the probability model may comprise a linear dynamical system associated with a continuous set of probability values, based on the historical data and/or the observed data. Alternatively or additionally the probability model may comprise a linear dynamical system associated with a continuous set of values of the flow rate in the conduit, based on the historical data and/or the observed data.

In some examples the Bayesian network may be associated with a graph of conditional probabilities function, such as a Hidden Markov Model, HMM.

In some examples, the HMM may be based on historical data associated with at least one fluid flow state; and/or based on prior probabilities and/or probability distributions of fluid flow states at one or more times, such as times t-1, prior to the given time t.

In some examples at least one of the prior probabilities and/or probability distributions is based on empirical test data.

In some examples, in the Hidden Markov Model, HMM, the historical data associated with the at least one fluid flow state comprise a predetermined number of discrete states, including e.g. at least a leak state and a non-leak state as already described in the present disclosure.

In some examples, at least one discrete state is assigned based on empirical test data. An example of implementation of a two-state HMM is described below.

The example HMM includes a 2-state Markov process z (e.g. leak and no-leak), and a single observed variable x (e.g. pipe temperature). The probability p that there is a leak at time t can be calculated using the following formula:

$$p ( {z}_{t} , {x}_{1 : t} ) = p ( {x}_{t} \vert {z}_{t} ) {\sum }_{{z}_{t - 1}} p ( {z}_{t} \vert {z}_{t - 1} ) p ( {z}_{t - 1} , {x}_{1 : t - 1} )$$

where:
p(xₜ|zₜ) is the probability of the current state given the current observation (e.g. observed data at the given time t);
p(zₜ|zₜ₋₁) is the probability of a transition from the previous state (e.g. at time t-1) to the current state (e.g. at the given time t);
p(zₜ₋₁, x_{1:t-1}) is the probability that there was a leak in the previous state, e.g. at t-1

Note that the previous state is also not known, so the sum may be performed over all possible states. Also note that the above formula is recursive, in that the final term p(zₜ₋₁, x_{1:t-1}) can also be calculated via a similar formula. As such, the probability of a leak must be updated as new observed data is collected, often referred to as a “forward pass”.

Counter-intuitively, the collection of new observed data might change a belief over previous states (e.g. at one or more times prior to the given time t). For example, a new observation included in the observed data might indicate that there is currently a leak, and tracing this indication backwards might indicate that the leak started some time in the past, even if it was not previously detected. This process is often referred to as “decoding”, and can be solved efficiently using the Viterbi algorithm known to the person skilled in the art.

The above terms can be calculated using the underlying probability model PM as illustrated in FIG. 4, which comprises e.g. at least one of the following three parameters:
an initial probability—e.g. a probability of there being a leak at the moment when the observed data has just started to be collected;
a transition probability—e.g. a probability of changing from one state to another (e.g. a leak starting) or even remaining in the same state (e.g. a leak continuing); and/or
an emission probability—e.g. a probability of a certain state (e.g. leak state) producing a certain observation (e.g. a pipe temperature of 15 degrees Celsius)

Any one of these parameters may be learned empirically from the observed data (e.g. empirical test data). In some examples, any one of the parameters may be used by the system 10 and/or the device 15, e.g. any one of the parameters may be hardcoded in the firmware of the system 10 and/or the device 15.

Below are described example steps according to a method 100 and/or 200 described above.

Example steps may include:

extracting e.g. five features from the ambient temperature T3 and the conduit temperature T1 (i.e. the observed data);

comparing the extracted features against threshold values to produce output flags, and

combining these output flags with user preferences to produce a leak status. Examples or extracted features, output flags and leak states have already been described in the present disclosure.

In some examples the extracted features may comprise at least one of the following, e.g. from the ambient and conduit temperature data:

1. MeanDiff—e.g. an average of the difference between the ambient temperature T3 and the conduit temperature T1, over a given past first time period;

2. DiffRange—e.g. a range of MeanDiff over a given past second time period;

3. PipeRange—e.g. a range of the conduit temperatures over a given past third time period;

4. PipeGradient—e.g. a gradient of the conduit temperature over a given fourth time period, such as a window, approximated by subtracting a value at a start of the window from a value at an end of the window;

5. PipeLinearity—e.g. an average absolute difference between the conduit temperature and a straight line connecting the most recent pipe temperature and the pipe temperature at a previous fifth time period ago.

The various time periods (first to fifth) may be the same duration, or may be different. Some time periods may be less than a minute, e.g. 30 or 45 seconds, while others may be a single digit number of minutes such as approximately 5 or 8 minutes for example. Alternatively, time periods may be 10 mins or more, or 20 or 30 minutes or more.

Convergence and non-convergence output flags are produced by comparing the extracted features described above to a set of fixed thresholds, for example:

Convergence
MeanDiff<a first threshold
DiffRange<=a second threshold

Non-Convergence
MeanDiff>a third threshold
DiffRange<=a fourth threshold
PipeRange<=a fifth threshold
PipeGradient<a sixth threshold
PipeLinearity<a seventh threshold

Again the thresholds for the different extracted features may be the same, or may be different. Values may be of the order of a few hundredths of a degree, e.g. 0.05 degrees, tenths of a degree, e.g. 0.1 or 0.2 degrees for example, approximately half a degree, or one or two degrees. The above temperature thresholds are non-limiting examples only, and other values may be envisaged.

As a result, non-convergence may be typically achieved e.g. 15-20 minutes after water starts flowing through a conduit for high flows, but can take up to 45 minutes for slow drips. Convergence may be typically achieved e.g. 2-3 hours after water has stopped flowing if no water has been used since, but it might not be achieved until overnight if water is used frequently during daytime.

The convergence and non-convergence flags may indicate the absence or presence of water flow, respectively.

In some examples, non-convergence may change the leak status to leak, while convergence may change the leak status to no leak.

Additionally or alternatively, long-running water flows may be considered to be unintentional (i.e. evidence of a leak), while short-running water flows are more likely to be intentional usage. Since some users might intentionally use water for longer durations than other users, we may ask the user to select a duration threshold, below which the device 15 and/or the system 10 may suppress changes in leak status. The person living in the property can select a duration threshold of either e.g. 15, 20 or 25 minutes, as non-limiting examples. For example, if the person living in the property selects a threshold of 20 minutes, water flows of less than 20 minutes in duration may not trigger a change in the leak status, while longer flows may trigger a change of leak status.

In some examples, the duration of a water flow may be calculated by comparing the time between a drop in the conduit temperature T1 (called a usage event) and a non-convergence flag. In some examples, usage flags may be produced according to at least one of the following criteria:

1. The conduit temperature has decreased by >=e.g. 0.3 degrees over e.g. 10 seconds

2. The conduit temperature has continued to decrease while the previous condition was true

3. The conduit temperature has decreased by >=e.g. 0.4 degrees over e.g. 20 seconds

4. The conduit temperature is surrounded by two usage flags

The example temperature thresholds and time periods are examples only, and other values may be envisaged.

Alternatively or additionally, the system 10 may be configured to classify a leak as a small leak if the flow rate is less than 3.5 L/h, while higher flow rates may be classified as large leaks. A flow rate of 3.5 L/h is roughly equivalent to a trickle of water, and therefore dripping leaks may be classed as small leaks, while continuous streams of water may be classed as large leaks. In some examples, the temperature of the water supply may be estimated and the leak severity may be classified by the ratio algorithm.

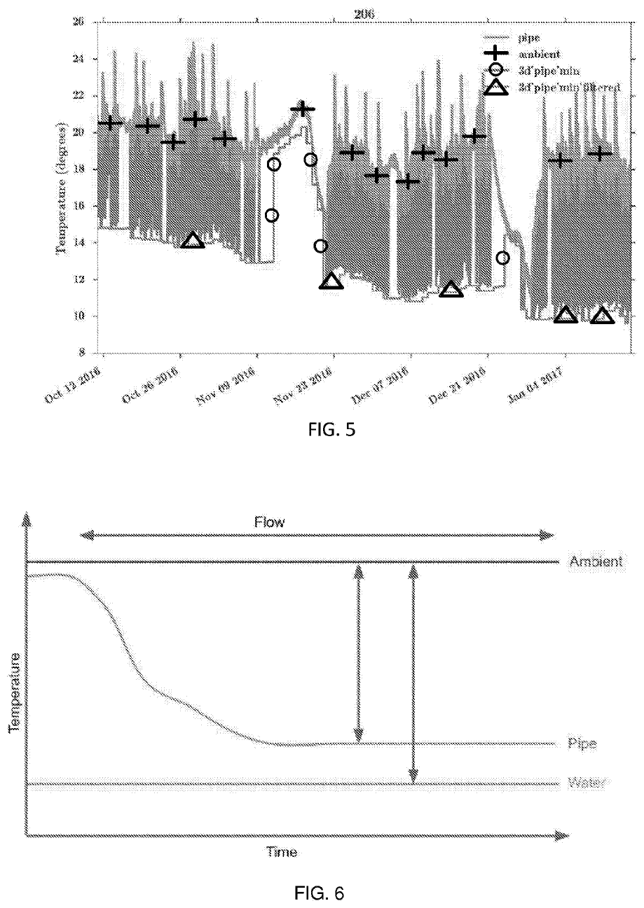

The supply temperature estimation may be described in more detail below. FIG. 5 schematically illustrates example data from a property over a three month period. FIG. 5 schematically illustrates that the conduit temperature drops by a few degrees every time a high flow event occurs.

In some examples, the temperature of the water supply (e.g. water temperature T2) may vary from one property to the next, and even across the year for the same property. As a result, the estimate of the supply temperature may be updated for each property every few days. In some examples, a minimum conduit temperature over a rolling three day window may provide an estimate of the water supply temperature (see FIG. 5), since the conduit typically reaches a temperature close to the water supply temperature under a sustained full-bore flow (e.g. a shower).

In some examples, during periods when water is not used (e.g. the property is unoccupied) the conduit temperature tracks the ambient temperature T3, and the minimum conduit temperature may not be a good estimate of water temperature (see FIG. 5). In such examples, the three day minimum conduit temperature may be updated when there may be a sustained full-bore flow during that three day period, which may be indicated by a difference between the ambient temperature and the conduit temperature greater than e.g. 1.5 degrees. In these cases, the last good estimate of the water supply temperature may be used.

The estimation of the flow ratio may be described in more detail below. FIG. 6 schematically illustrates the ambient and conduit temperatures as measured by the device 15, and the water temperature as estimated by the water supply estimation described above. FIG. 6 also indicates the numerator and denominator of the flow ratio calculation.

In some embodiments, each leak may be classified as either a large or small leak. The flow rate may be assumed to be proportional to the decrease in the conduit temperature T1 during the leak, relative to the water temperature T2. As such, higher flow rates may result in a conduit temperature T1 closer to the water supply temperature T2, while lower flow rates may result in a conduit temperature T1 closer to the ambient temperature T3.

In some examples, the flow ratio r may be calculated by dividing the difference between the ambient temperature T3 and the conduit temperature T1 by the difference between the ambient temperature T3 and the water temperature T2, such that:

$$r = \frac{( T 3 - T 1 )}{( T 3 - T 2 )} .$$

In some examples, a leak may be classified as a large leak if the ratio r is greater than 0.6, while lower ratios r may be classified as small leaks.

In some examples, the empirical test data mentioned above may be based on at least one of user data associated with a user input (including e.g. a person living in the property and/or a person who installed the system) and/or the observed data associated with the property (including e.g. images of the system's installation). The user data and/or the observed data may be obtained using a Graphical User Interface, GUI, such as the interface 50. Examples of interfaces may include at least one of the following: web-based, and/or spreadsheets and/or text files.

Examples of empirical test data may include inputs associated with at least one of the following:

whether there was or was not a leak in the property, and/or

a severity of the leak, and/or

whether water was intentionally used for a short period of time, and/or

whether there was some problem with the data (e.g. sensor has been installed incorrectly).

In some example the user data associated with the user input and/or the observed data associated with the property may comprise labelling of the observed data OD. In some examples the labels may represent what is thought, e.g. by a human expert at an operator of the system 10 (supported by data from a user input) to be e.g. a leak or water usage.

Labelling may enable enhanced accuracy of leak detection, reduction of false alerts without reducing a capability to detect genuine leaks, and/or reduce the time required to determine with confidence whether a leak has been fixed or not.

A user may label the OD, e.g. using an interface, e.g. using labels referring to states such as:

Undefined state—e.g. when no labelling has been done, but the user has viewed a sample of the OD, and/or

No Leak—e.g. when it is believed that there is No Leak, and/or

Small Leak—e.g. when it is believed that there is a Leak in the property but it is too small for a current method to detect it, and/or

Medium Leak—e.g. when it is believed there was a Leak that the user should be notified about, and/or

Large Leak—e.g. when it is believed that there was a Leak that can cause damage in a short period of time, and/or

Long Usage—when it is believed that the user intentionally used water for e.g. fifteen minutes or more, and/or

No data—not enough data to make decision, and/or

Miscalibrated—when it is believed that a calibration was incorrect, and/or

Invalid—when data is invalid.

In some examples, the measure representative of the fluid flow and/or the observed data may be filtered by a sliding window.

In some examples, the sliding window may comprise two parameters. A first parameter may include a length of the window (e.g. 15 minutes or 100 data samples as non-limiting examples). Alternatively or additionally, a second parameter may include a threshold for a number of positive detections (e.g. detection of a leak) required to trigger a notification, e.g. ten positive detections.

The window can be shortened and the threshold can be lowered to give quicker but less accurate results, and vice versa.

### Modifications and Variations

The user interface 50 may be a user interface of a communications device associated with a client associated to the property 60 and/or a device associated with an operator of the utility provider (water and/or gas provider) and/or a device associated with a third party. The communications device may comprise at least one of a computer, a telephone, such as a cell phone, a personal digital assistant (PDA), a laptop or electronic notebook, a smart phone, a tablet, any other type of smart device, and/or a server of the operator and/or a server of a third party, as non-limiting examples.

In some examples, the links 30 and 40 may be any communications network (such as the Internet or a mobile telephony network, using technology such as wired, such as cable and/or Ethernet, or wireless, such as mobile telephony or Wi-Fi technologies, as non-limiting examples.

In example embodiments, the system 10 and/or the device 15 may be configured as one or more networks. Additionally, networks may be provisioned in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In example embodiments, elements of the system 10 and/or the device 15 may be coupled to one another through one or more interfaces employing any suitable connection (wired or wireless), which provides a viable pathway for electronic communications. Additionally, any one or more of these elements may be combined or removed from the architecture based on particular configuration needs. The system 10 and/or the device 15 may include a configuration capable of transmission control protocol/Internet protocol (TCP/IP) communications for the electronic transmission or reception of packets in a network. The system 10 and/or the device 15 may also operate in conjunction with a user datagram protocol/IP (UDP/IP) or any other suitable protocol, where appropriate and based on particular needs. In addition, gateways, routers, switches, and any other suitable network elements may be used to facilitate electronic communication between various elements.

In example embodiments, components of the system 10 and/or the device 15 may use specialized applications and hardware. The system 10 and/or the device 15 can use Internet protocol (IP) technology.

In example implementations, at least some portions of the system 10 and/or the device 15 may be implemented in software. In some embodiments, one or more of these portions may be implemented in hardware, provided external to these elements, or consolidated in any appropriate manner to achieve the intended functionality. In still other embodiments, these elements may include any suitable algorithms, hardware, software, components, modules, interfaces, or objects that facilitate the operations thereof.

In a particular implementation, the system 10 and/or the device 15 is a server provisioned to perform the activities discussed herein. A server may be located on a single real or virtual location, but may also distributed on a number of different real or virtual locations.

In some of example embodiments, one or more memory elements (e.g., the memory element 11 or 151) can store data used for the operations described herein. This includes the memory element being able to store software, logic, code, or processor instructions that are executed to carry out the activities described in this disclosure.

A processor can execute any type of instructions associated with the data to achieve the operations detailed herein in this disclosure. In one example, the processor 12 or 152 could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, components in the system 10 and/or the device 15 can include one or more memory elements (e.g., the memory element 11 or 151) for storing information to be used in achieving the operations as outlined herein. These devices may further keep information in any suitable type of memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the system 10 and/or the device 15 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this disclosure should be construed as being encompassed within the broad term ‘processor.’

Additionally, some of the processors and memory elements associated with the system and/or the device may be removed, or otherwise consolidated such that a single processor and a single memory location are responsible for certain activities. In a general sense, the arrangements depicted in the FIGURES may be more logical in their representations, whereas a physical architecture may include various permutations, combinations, and/or hybrids of these elements. Countless possible design configurations can be used to achieve the operational objectives outlined here. Accordingly, the associated infrastructure has a myriad of substitute arrangements, design choices, device possibilities, hardware configurations, software implementations, equipment options, etc.

Although the present disclosure has been described in detail with reference to particular arrangements and configurations, these example configurations and arrangements may be changed significantly without departing from the scope of the present disclosure.

1. A computer-implemented method for estimating, at a given time, a fluid flow state in a conduit of a property, comprising:
obtaining historical data associated with at least one fluid flow state in the conduit, wherein the historical data comprises a history of the probability of the at least one fluid flow state in the conduit;
obtaining a probability model for the at least one fluid flow state, wherein a probability for the at least one fluid flow state is a function of the historical data associated with the at least one fluid flow state;
obtaining observed data associated with the property, the observed data including a measure representative of a fluid flow in the conduit; and
estimating a fluid flow state in the conduit of the property at the given time, based on:
the historical data associated with the at least one fluid flow state,
the probability model, and
the observed data;
wherein estimating the fluid flow state comprises assigning a probability of a flow state at the given time, wherein the probability at the given time is a function of the probability at one or more previous times prior to the given time.

2. The method of claim 1, wherein the at least one fluid flow state includes one of a predetermined set of discrete states including at least one of a leak state, a non-leak state, a low severity leak state, a medium severity leak state, a high severity leak state, a device off-pipe state, a device poor connection state, and a filling of header tanks state.

3. The method of claim 1, wherein the at least one fluid flow state includes one value of a continuous set of values associated with the fluid flow in the conduit of the property, such as a flow rate in the conduit.

4. The method of any of claim 1, wherein the observed data includes:
a history of measures associated with the property and/or the flow in the conduit.

5. The method according to claim 1, wherein estimating the fluid flow state comprises assigning a probability of a flow state at one or more previous times prior to the given time.

6. (canceled)

7. The method of claim 1, wherein the probability at the given time is a function of:
the probability of the flow state given the observed data at the given time and the probability of a transition from a previous state at an earlier time to the flow state at the given time.

8. The method of claim 1, wherein the fluid flow state in the conduit at the given time is estimated by comparing the assigned probability to a predetermined probability threshold, wherein the predetermined probability threshold is at least partly determined based on a user input associated with a detection sensitivity level chosen by the user.

9. (canceled)

10. The method of claim 1, further comprising:
outputting trigger data to trigger an intervention in response to estimating that the flow state at the given time is a leak state.

11. The method of claim 1, comprising obtaining the observed data associated with the property at the given time and/or at one or more previous times prior to the given time, wherein obtaining the observed data comprises:
extracting features from temperature data;
comparing the extracted features against threshold values to produce output flags, such as a convergence flag and/or a non-convergence flag, and
combining produced output flags with user preferences to produce a leak status.

12. The method of claim 1, for detecting a leak, at a given time, in the conduit of the property,
wherein the at least one fluid flow state is a leak state,
wherein a probability of the at least one fluid flow state being a leak state at the given time is a function of:
the historical data comprising a probability of the at least one fluid flow state being a leak state at one or more previous times prior to the given time, and
the observed data at the given time or at one or more previous times;
wherein estimating the fluid flow state comprises assigning a probability of the at least one fluid flow state being a leak state at the given time or at one or more previous times using the probability model;
the method further comprising:
determining a likelihood of a leak in the conduit of the property, based on the assigned probability; and
outputting an alert in response to determining a likely leak in the conduit of the property.

13. (canceled)

14. (canceled)

15. (canceled)

16. The method of claim 1, wherein the probability model comprises one of: a Bayesian network, and a Hidden Markov Model, HMM, and wherein the HMM is based on historical data associated with at least one fluid flow state and/or based on prior probabilities and/or probability distributions of fluid flow states at one or more times prior to the given time, wherein at least one of the prior probabilities and/or probability distributions is based on empirical test data.

17. (canceled)

18. (canceled)

19. (canceled)

20. The method according to claim 16, wherein, in the Hidden Markov Model, HMM, the historical data associated with the at least one fluid flow state comprise a predetermined number of discrete states, including at least a leak state and a non-leak state, wherein at least one discrete state is assigned based on empirical test data, optionally wherein the empirical test data is based on at least one of user data associated with a user input and/or the observed data associated with the property.

21. (canceled)

22. The method according to claim 1, wherein the probability p that there is a leak at time t is such that:
$$p ( {z}_{t} , {x}_{1 : t} ) = p ( {x}_{t} \vert {z}_{t} ) {\sum }_{{z}_{t - 1}} p ( {z}_{t} \vert {z}_{t - 1} ) p ( {z}_{t - 1} , {x}_{1 : t - 1} )$$
where:
p(xₜ|zₜ) is the probability of the current state given the observed data at the given time t;
p(zₜ|zₜ₋₁) is the probability of a transition from the previous state at time t-1 to the current state at the given time t;
p(zₜ₋₁, x_{1:t-1}) is the probability that there was a leak in the previous state at time t-1.

23. (canceled)

24. The method of claim 1, wherein the probability model comprises a linear dynamical system associated with a continuous set of one of: probability values and values of the flow rate in the conduit, based on the historical data and/or the observed data.

25. The method of claim 1, wherein the measure representative of the fluid flow comprises one or more of:
temperature data based on a temperature of the conduit and/or a temperature of a fluid in the conduit, such as an average and/or a range;
a gradient of the temperature of the conduit;
a gradient of the temperature of the fluid in the conduit;
a measure of the linearity of the gradient of the conduit temperature; and
data associated with a fluid meter.

26. (canceled)

27. The method of claim 1, wherein the measure representative of the fluid flow and/or the observed data are filtered by a sliding window.

28. (canceled)

29. The method of claim 1, wherein the observed data comprises one or more of:
temperature data based on at least one of:
a temperature of the property, such as a temperature in a room of the property; and/or
a temperature external to the property, such as a meteorological temperature;
a flow ratio; and
a difference between:
on the one hand, the temperature of or external to the property, and
on the other hand, a temperature of the conduit or a temperature of a fluid in the conduit.

30. (canceled)

31. The method of claim 1, comprising classifying a leak state into different leak types based on a size of the leak, optionally as either a large leak or small leak.

32. Apparatus comprising a memory and a processor, the memory comprising instructions which, when executed by the processor, enable the apparatus to perform a method for estimating, at a given time, a fluid flow state in a conduit of a property, the instructions comprising instructions for:
obtaining historical data associated with at least one fluid flow state in the conduit, wherein the historical data comprises a history of the probability of the at least one fluid flow state in the conduit;
obtaining a probability model for the at least one fluid flow state, wherein a probability for the at least one fluid flow state is a function of the historical data associated with the at least one fluid flow state;
obtaining observed data associated with the property, the observed data including a measure representative of a fluid flow in the conduit; and
estimating a fluid flow state in the conduit of the property at the given time, based on:
the historical data associated with the at least one fluid flow state,
the probability model, and
the observed data;
wherein estimating the fluid flow state comprises assigning a probability of a flow state at the given time, wherein the probability at the given time is a function of the probability at one or more previous times prior to the given time.

33. A non-transitory computer readable medium comprising instructions which, when executed by a processor, enable the processor to perform a leak detection method for detecting a leak, at a given time, in a conduit of a property, the instructions configured for:
obtaining observed data including a measure representative of a fluid flow in the conduit;
obtaining a probability model for at least one fluid flow state being a leak state,
wherein a probability of the at least one fluid flow state being a leak state at the given time is a function of:
historical data comprising a probability of the at least one fluid flow state being a leak state at one or more previous times prior to the given time, and
the observed data at the given time or at one or more times prior to the given time;
assigning a probability of the at least one fluid flow state being a leak state at the given time or at one or more times prior to the given time using the probability model;
determining a likelihood of a leak in the conduit of the property, based on the assigned probability; and
outputting an alert in response to determining a likely leak in the conduit of the property.
